(19) United States
(12) Patent Application Publication
(10) Pub. No.: US 2005/0047048 A1
(43) Pub. Date: Mar. 3, 2005

(54) Over-voltage protection coil control circuit

(75) Inventors: Hsu-Yuan Chin, Hsinchu (TW); Wen-Chi Lin, Nantour (TW)

Correspondence Address: Troxell Law Office PLLC, Suite 1404, 5205 Leesburg Pike, Falls Church, VA, 22041, US

(73) Assignee: Silicon Touch Technology Inc.

(21) Appl. No.: 10/648,200

(22) Filed: Aug. 27, 2003

(51) Int. Cl. H02H 9/06

(52) U.S. Cl. 361/118

(57) ABSTRACT

An over-voltage protection coil control circuit has at least one coil driving circuit, wherein an over-voltage protection circuit is connected to the at least one coil driver circuit. The at least one coil driver circuit consists of a transistor. The over-voltage protection circuit is composed of a Zener diode connected to a power supply and the at least one coil driver circuit. When the coil generates a high inverse emf (electromotive force) due to the inversion of its polarity, the Zener diode conducts and guides the high voltage inverse emf to the power supply.

### BACKGROUND OF THE INVENTION

1. Field of Invention

The invention relates to an over-voltage protection coil control circuit and, in particular, to a control circuit having at least one coil driver circuit that can change the voltage threshold in an over-voltage protection circuit according to the voltage of the power supply.

2. Related Art

To keep the high inverse emf (electromotive force) produced when the polarities of the coils in a brushless DC fan or DC motor reverse from damaging the driver circuit, a method currently used connects a simple protection circuit consisting of a Zener diode to the coil. The protection circuit shunts the sudden high inverse emf to ground and thus protects the coil driver circuit.

With reference to FIG. 4, a conventional over-voltage protection circuit 60 is used in the control circuit of a brushless DC fan. The control circuit includes a Hall sensor 50, an amplifier 51, a pulse generator 52, one or more driver circuits 53 and over-voltage protection circuits 60 corresponding to each driver circuit 53. The Hall sensor 50 detects the polarity changes on the two coils L1, L2 in the brushless fan. The amplifier 51 connects to the output terminal of the Hall sensor 50 to amplify the detection signal of the Hall sensor 50. The pulse generator 52 connects to the output terminal of the amplifier 51. Each driver circuit 53 consists of transistors Q1, Q2. The base of each transistor Q1, Q2 is connected to a corresponding output terminal of the pulse generator 52 and the collector connects to the corresponding coil L1, L2 of the brushless fan. Each of the over-voltage protection circuits 60 connects between the corresponding collector of the transistors Q1, Q2 in the driver circuits 53 and ground. The over-voltage protection circuit 60 is a Zener diode Z1, Z2.

At the instant the two coils L1, L2 interchange, the coil L1 through which the current stops passing effectively discharges and generates a high inverse emf, which drives the current to the collector of the transistor Q1 in the driver circuit 53. Due to the operation of the Zener diode Z1 in the protection circuit when the inverse emf reaches the Zener diode's Z1 breakdown voltage, the inverse emf is guided through the Zener diode Z1 to ground. The operation of the Zener diode Z1 ensures that the full force of the inverse emf is not applied to the transistor Q1, which would cause it to burn out. Since the breakdown voltage of the Zener diodes Z1, Z2 in the over-voltage protection circuits 60 is a characteristic of the particular diode, the reverse emf applied to the transistors Q1, Q2 does not decrease even when the power supply voltage is lowered.

With reference to FIGS. 5A and 5B, the output voltage at the collector of the transistor Q1 in the driver circuit 53 is shown when the control circuit is under different work voltage. In FIG. 5A, the power supply voltage of the control circuit is 12V and the breakdown voltage of the Zener diode Z1 is VZ. When a high inverse emf is produced, Z1 transmits immediately due to the instantaneous high voltage, limiting the collector voltage of the transistor Q1 to a constant VZ. In FIG. 5B, when the power supply voltage of the control circuit is lowered to 5V, the high inverse emf is produced when the current through the coils L1, L2 is switched. Because the Zener diode Z1 still breaks down at the same voltage, the peak voltage at the collector of the transistor Q1 is still VZ.

Most current brushless DC fans are equipped with many controls. For example, the fan speed can be adjusted by changing the power supply voltage. As previously described however, the control protection circuit 60 limits the coil generated high inverse emf to a constant value VZ but cannot change the limit voltage value according to different power supply voltages. Therefore, such control protection circuits are not completely satisfactory.

### SUMMARY OF THE INVENTION

The objective of the invention is to provide an over-voltage protection coil control circuit, wherein the coil control circuit has an over-voltage protection circuit. The over-voltage protection circuit can limit the inverse emf voltage on the coil according to the power supply voltage variation.

To achieve the foregoing objective, the main technique of the invention is to connect the over-voltage protection circuit to one or more than one sets of driver circuits. Each driver circuit consists of a transistor and is connected to a coil. When the coil produces a high inverse emf due to the change in polarity, the over-voltage protection circuit can guide the high inverse emf to ground.

### BRIEF DESCRIPTION OF THE DRAWINGS

FIG. 1 is a block diagram of an over-voltage protection coil control circuit in accordance with the present invention;

FIG. 2 is a circuit diagram of an embodiment of an over-voltage protection coil control circuit in accordance with the present invention;

FIGS. 3A and 3B are voltage response graphs illustrating the output voltage of the transistor N1 in the driver circuit in FIG. 1;

FIG. 4 is a circuit diagram of a conventional coil control circuit with a power-voltage protection circuit in accordance with the prior art; and

FIGS. 5A and 5B are voltage response graphs illustrating the output voltage of the transistor Q1 in the drive circuit in FIG. 3.

### DETAILED DESCRIPTION OF THE INVENTION

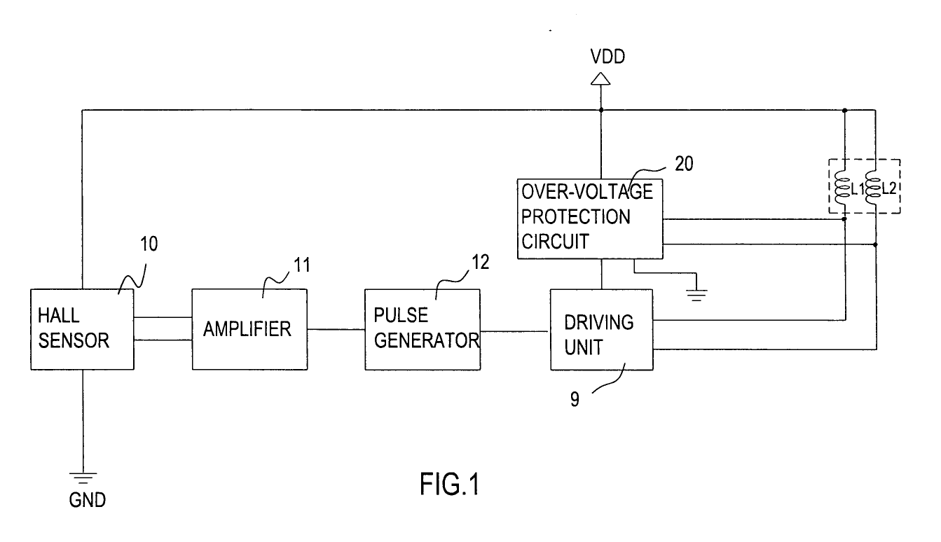

With reference to FIG. 1, an over-voltage protection coil control circuit comprises a Hall sensor 10, an amplifier 11, a pulse generator 12, an over-voltage protection circuit 20 and a driving unit 9 and two coils L1, L2. When the Hall sensor 10 detects a polarity change in coils L1 or L2, a Hall signal is output and amplified by the amplifier 11. The amplified signal causes the pulse generator 12 to generate HIGH and LOW level voltage signals to control the driving unit 9 to drive coils L1 or L2. When the coils L1 or L2 change its polarity, the coils L1 or L2 generate a high inverse emf (electromotive force), and then the over-voltage protection circuit 20 immediately limits the high inverse emf so as to protect the driving unit 9 and the coils L1 and L2.

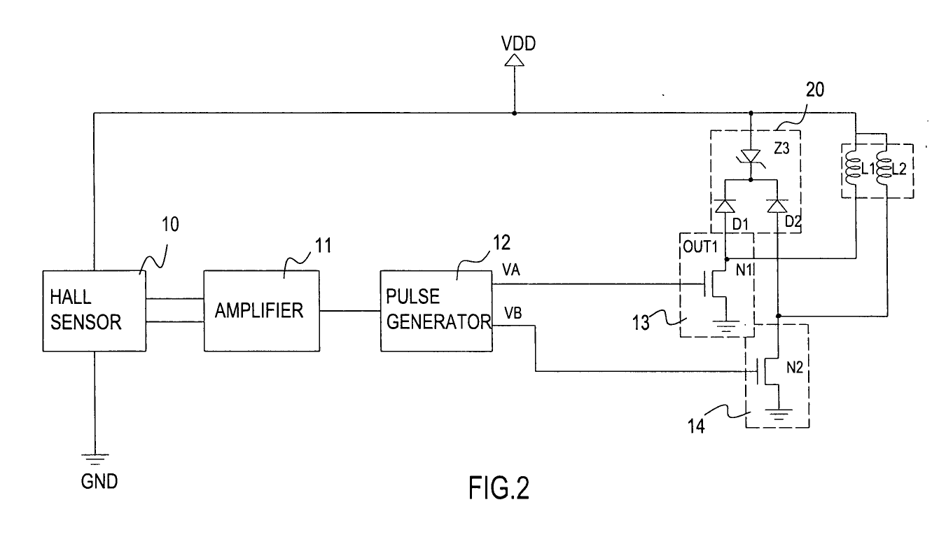

With reference to FIG. 2, the detailed circuit of the driving unit 9 and the over-voltage protection circuit 20 is clearly shown. The driving unit 9 comprises two driver circuit 13, 14. The Hall sensor 10 detects the polarity changes on the two coils L1, L2 in the DC fan. The amplifier 11 connects to the output terminal of the Hall sensor 10 to amplify the detection signal from the Hall sensor 10. The pulse generator 12 connects to the output terminal of the amplifier 11. Each of the driver circuits 13, 14 is comprised of an FET (Field Effect Transistor) N1, N2. The drains of the FETs N1, N2 connect to the over-voltage protection circuit 20 and connect to the respective coil L1, L2 of the brushless fan. The gates of the FETs N1, N2 connect to the respective output terminal VA, VB of the pulse generator 12.

Each of the FETs N1, N2 can be replaced by a BJT (Bipolar Junction Transistor). If the BJT is used, its base is connected to the pulse generator 12, and its collector is connected to the corresponding coil.

The over-voltage protection circuit 20 includes an Zener diode Z3, and two diodes D1, D2. The drains of the FETs N1, N2 in the driver circuits 13, 14 connect to the negative poles of diodes D1, D2, respectively. Both of the positive poles of the two diodes D1, D2 connect to the negative pole of the Zener diode Z3. The positive pole of the Zener diode Z1 connects to the power supply VDD.

The circuit operation will be explained by using the over-voltage protection circuit 20 and FET N1 in the driver circuit 13 as an example. When the Hall sensor 10 detects a polarity change in coil L1, a Hall signal is output and amplified by the amplifier 11. The amplified signal causes the pulse generator 12 to generate HIGH and LOW level voltage signals to control the FET N1. When the gate of the FET N1 receives the HIGH level voltage signals, the FET N1 is driven to ON.

When the output terminal VA of the pulse generator 12 turns from HIGH to LOW, the original conducting FET N1 changes to OFF. When current stops moving through the coil L1, the coil L1 generates a high inverse emf on the drain of the FET N1 at the instant the current is switched. The circuit in the current embodiment adjusts the limit voltage value for the inverse emf according to the breakdown voltage VZ of the Zener diode Z1. The potential of the inverse emf is greater than the voltage level of the limit voltage (VDD+VZ), thus the Zener diode Z3 and the diode D1 conduct so as to lead the high voltage away from the power supply when the coil L1 generates a high inverse emf due to the polarity changes.

Analogously, when the coil L2 changes its polarity, the actions of the FET N2, the diode D2 and the Zener diode Z3 are the same as above, and thus the description will not be repeated.

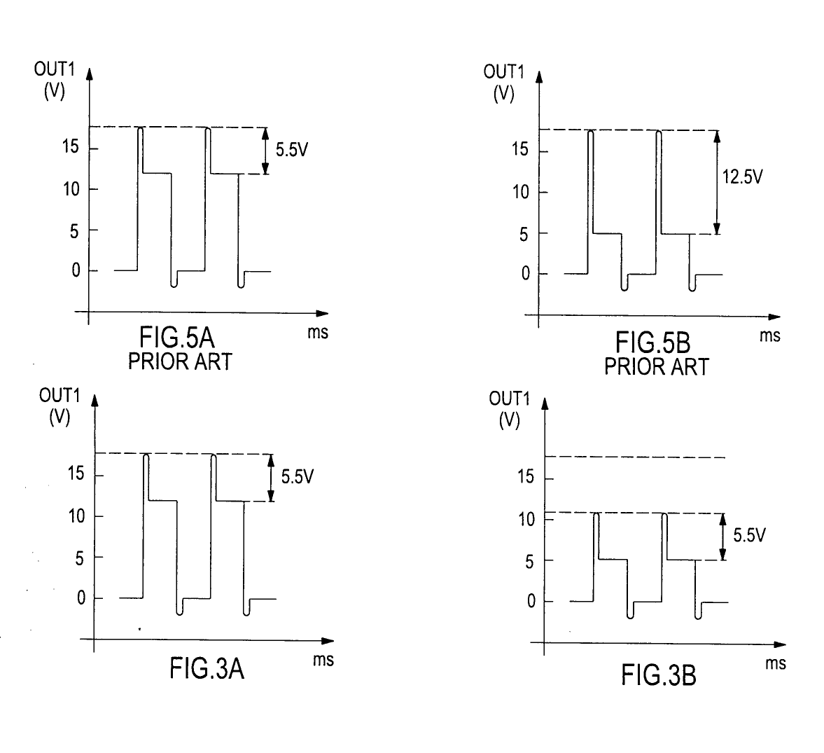

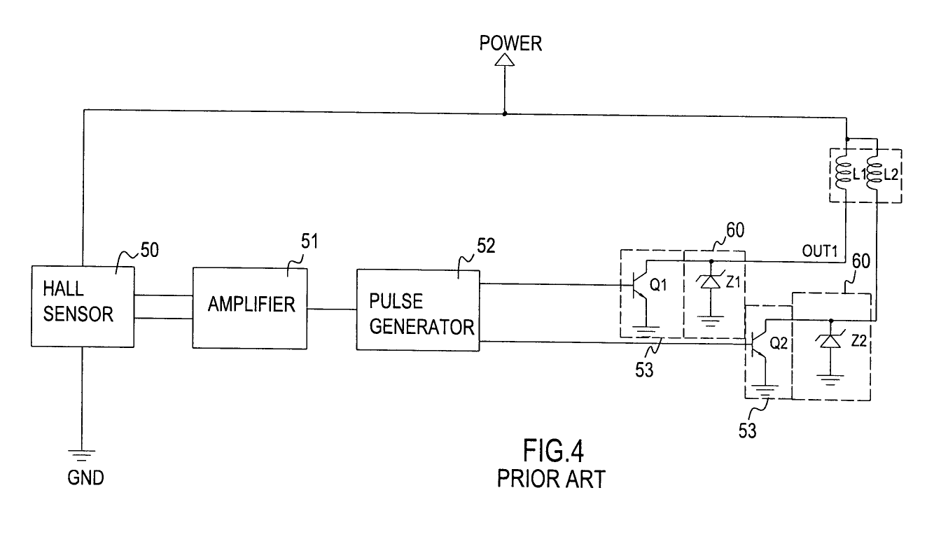

In FIG. 3A, the power supply voltage VDD of the control circuit is 12V and the breakdown voltage VZ is 5.5V. When a high inverse emf is produced, the voltage at the drain of the FET N1 is limited to 17.5V. In FIG. 3B, when the power supply voltage of the control circuit is lowered to 5V and the breakdown voltage VZ is still 5.5V, the high inverse emf at the drain of the FET N1 is limited to 10.5V. In comparison with the voltage response of the conventional over-voltage protection circuit as reflected in FIGS. 3A and 3B, it is clear that the over-voltage protection circuit 20 in accordance with the present invention adapts the peak voltage of the high inverse emf based on the power supply voltage VDD.

As described, the over-voltage protection circuit uses a simple circuit to achieve the object of protecting the coil driver circuit in the control circuit of a fan. It can change and fix the limit voltage as the power supply voltage is changed. Thus, the protection circuit can adjust the limit reference voltage according to the needs of various types of coil driver circuits (e.g. DC motors and coil driver circuits in brushless DC fans). Through the adjustment of the limit reference voltage, the invention achieves the goal of tracking the limit voltage of the power supply variation and elongating the life of a driver circuit.

The invention may be varied in many ways by a person skilled in the art. Such variations are not to be regarded as a departure from the spirit and scope of the invention, and all such modifications are intended to be included within the scope of the following claims.

1. An over-voltage protection coil control circuit comprising:
a power supply;
a Hall sensor (10) adapted to connect to coils to detect polarity changes on the coils;
a pulse generator (12) connecting to the Hall sensor (10) and having two output terminals;
two driver circuit (13,14), wherein each driver circuit (13,14) is a transistor connecting to each corresponding output terminal of the pulse generator (12) and each corresponding coil;
an over-voltage protection circuit (20) containing a Zener diode having a positive pole and a negative pole, wherein the positive pole of the Zener diode is connected to the power supply, and the negative pole of the Zener diode is connected to the transistors in each driver circuit (13,14);
wherein the coils produce a high inverse emf due to the polarity inversion when the transistors change from ON to OFF, and the Zener diode is conducted to guide the high inverse emf to the power supply.

2. The control circuit as claimed in claim 1, wherein the negative pole of the Zener diode is further connected to negative poles of two diodes, and positive poles of the two diodes are respectively connected to the transistors in the each driver circuit (13,14).

3. The control circuit as claimed in claim 2, wherein each transistor in each driver circuit (13,14) is an FET transistor, and gates of the FET transistors are respectively connected to the two output terminals of the pulse generator (12), drains of the FET transistors are respectively connected to corresponding coils and each positive pole of each diode.

4. The control circuit as claimed in claim 2, wherein each transistor in each driver circuit (13,14) is a BJT transistor, and bases of the BJT transistors are respectively connected to the two output terminals of the pulse generator (12), collectors of the BJT transistors are respectively connected to corresponding coils and each positive pole of each diode.

5. The control circuit as claimed in claim 3, wherein an amplifier (11) is further connected between the Hall sensor (10) and the pulse generator (12).

6. The control circuit as claimed in claim 4, wherein an amplifier (11) is further connected between the Hall sensor (10) and the pulse generator (12).
